(19) United States
(12) Patent Application Publication
(10) Pub. No.: US 2021/0232939 A1
(43) Pub. Date: Jul. 29, 2021

(54) Distributed Computing System for Customizable Transformation of Graphical User Interface

(71) Applicant: Discotech Enterprises Inc., Chicago, IL (US)

(72) Inventors: Elizabeth Faye BARTLETT, Wildwood, MO (US); Oscar Javier PINEDA-MADRID, II, St. Charles, MO (US); Virgil Michael SCOTT, Lake St. Louis, MO (US)

(21) Appl. No.: 16/888,820

(22) Filed: May 31, 2020

Related U.S. Application Data
(60) Provisional application No. 62/965,462, filed on Jan. 24, 2020.

(51) Int. Cl. G06N 5/02; H04L 29/08; G06Q 10/06

(52) U.S. Cl. CPC G06N 5/025; G06Q 10/06; H04L 67/306; G06N 5/022

(57) ABSTRACT

A system creates a user profile based on information obtained about the user and action items pertaining to the user. Based on the user profile, a road map is developed to enable the user to achieve goals based on the user profile. An initial to-do list is generated based on the goals and action items. Action items are assigned based on the to-do list. Action items are assigned based on the goals. As the user profile is created, a prioritization of the action items may be reconfigured based on changes to the user profile.

### CROSS-REFERENCE TO RELATED APPLICATIONS

This application claims the benefit of U.S. Provisional Application No. 62/965,462 filed Jan. 24, 2020. The entire disclosure of the application referenced above is incorporated by reference.

### FIELD

The present disclosure relates to systems and methods for generating user interfaces and more particularly to systems and methods for dynamically prioritizing rendering user-specific items in a custom user interface.

### BACKGROUND

When generating a process for a user to achieve a user determined goal, a series of major and minor steps can obfuscate the path to the goal. This process can further be complicated by many degrees of freedom and the addition of steps after the process has been initiated.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to at least some example embodiments, a system includes a memory configured to store a plurality of action items and a rules engine configured to order the action items based on at least one of a plurality of conditions, the conditions including a user profile, a goal priority list, an action item category, a recurrence rule, a completed action item, an excluded action item, and an assigned action item. The ordered action items are dynamically re-ordered by the rules engine in response to a status change in any of the plurality of action items or a condition change in any of the plurality of conditions.

According to at least some example embodiments, a method includes generating a profile of a user; based on the profile, assigning a goal, from among a plurality of goals, as a primary goal of the user, the plurality of goals corresponding, respectively, to a plurality of sets of action items from among a plurality of action items; assigning a first set of action items, from among the plurality of action items, to an action item list of the user, the first set of action items being the set of action items, from among the plurality of sets of action items, that corresponds to the primary goal; and causing an electronic device to display the first set of action items.

Generating the profile of the user may include presenting, by the electronic device, the user with first questions from among plurality of questions and obtaining first answers corresponding to the first questions.

The method may further include determining, based on an answer provided by the user, at least one question from among the plurality of questions to be irrelevant and omitting the determined at least one question from the first questions.

The method may further include based on the profile of the user, assigning one or more goals, other than the primary goal, from among the plurality of goals, as one or more inactive goals of the user.

The one or more inactive goals may include at least two inactive goals and a priority order of the at least two inactive goals may be based on the profile of the user.

The method may further include, in response to the primary goal being completed, setting the inactive goal having a highest priority among the at least two inactive goals as a new primary goal.

The method may further include assigning a second set of action items, from among the plurality of action items, to the action item list of the user, the second set of action items being the set of action items, from among the plurality of sets of action items, that corresponds to the new primary goal; and causing the electronic device to display the second set of action items.

Generating the profile of the user may include presenting, by the electronic device, the user with first questions from among plurality of questions and obtaining first answers corresponding to the first questions.

The method may further include determining, based on an answer provided by the user, at least one question from among the plurality of questions to be is irrelevant and omitting the determined at least one question from the first questions.

The method may further include based on the profile of the user, assigning one or more goals, other than the primary goal, from among the plurality of goals, as one or more inactive goals of the user, the one or more inactive goals including at least two inactive goals, and a priority order of the at least two inactive goals being based on the profile of the user.

According to at least some example embodiments, a computer system includes memory storing computer-executable instructions and a processor configured to execute the computer-executable instructions. The computer-executable instructions include generating a profile of a user, based on the profile, assigning a goal, from among a plurality of goals, as a primary goal of the user,

the plurality of goals corresponding, respectively, to a plurality of sets of action items from among a plurality of action items, assigning a first set of action items, from among the plurality of action items, to an action item list of the user, the first set of action items being the set of action items, from among the plurality of sets of action items, that corresponds to the primary goal, and causing an electronic device to display the first set of action items.

Generating the profile of the user may include presenting, by the electronic device, the user with first questions from among plurality of questions and obtaining first answers corresponding to the first questions.

The computer-executable instructions may include determining, based on an answer provided by the user, at least one question from among the plurality of questions to be irrelevant and omitting the determined at least one question from the first questions.

The computer-executable instructions may include based on the profile of the user, assigning one or more goals, other than the primary goal, from among the plurality of goals, as one or more inactive goals of the user.

The one or more inactive goals may include at least two inactive goals and a priority order of the at least two inactive goals is based on the profile of the user.

The computer-executable instructions may include, in response to the primary goal being completed, setting the inactive goal having a highest priority among the at least two inactive goals as a new primary goal.

The computer-executable instructions may include assigning a second set of action items, from among the plurality of action items, to the action item list of the user, the second set of action items being the set of action items, from among the plurality of sets of action items, that corresponds to the new primary goal; and causing the electronic device to display the second set of action items.

Generating the profile of the user may include presenting, by the electronic device, the user with first questions from among plurality of questions and obtaining first answers corresponding to the first questions.

The computer-executable instructions may include determining, based on an answer provided by the user, at least one question from among the plurality of questions to be is irrelevant and omitting the determined at least one question from the first questions.

### BRIEF DESCRIPTION OF THE DRAWINGS

The present disclosure will become more fully understood from the detailed description and the accompanying drawings.

FIG. 1A illustrates a user specific action prioritization system 101.

FIG. 1B is a flowchart depicting a method for generating a user specific process according to the principles of the present disclosure.

FIGS. 2A-2E illustrate example screens for collecting financial information in order to create a financial profile of a user according to the principles of the present disclosure.

FIG. 2F illustrates a progress indicator according to the principles of the present disclosure.

FIG. 3 is a flowchart depicting an example of a road map logic for assigning goals to a user.

FIG. 4 is a flowchart depicting a method for dynamically prioritizing action items of the user specific process from FIG. 1B according to the principles of the present disclosure.

FIG. 5 is a flowchart depicting a method for generating a user specific process according to the principles of the present disclosure.

In the drawings, reference numbers may be reused to identify similar and/or identical elements.

### DETAILED DESCRIPTION

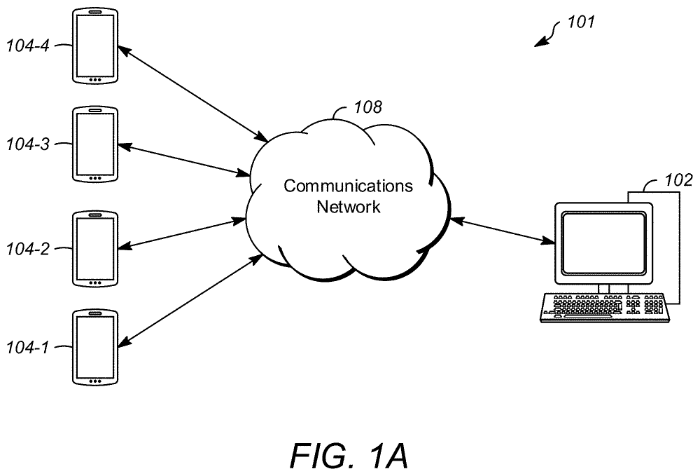

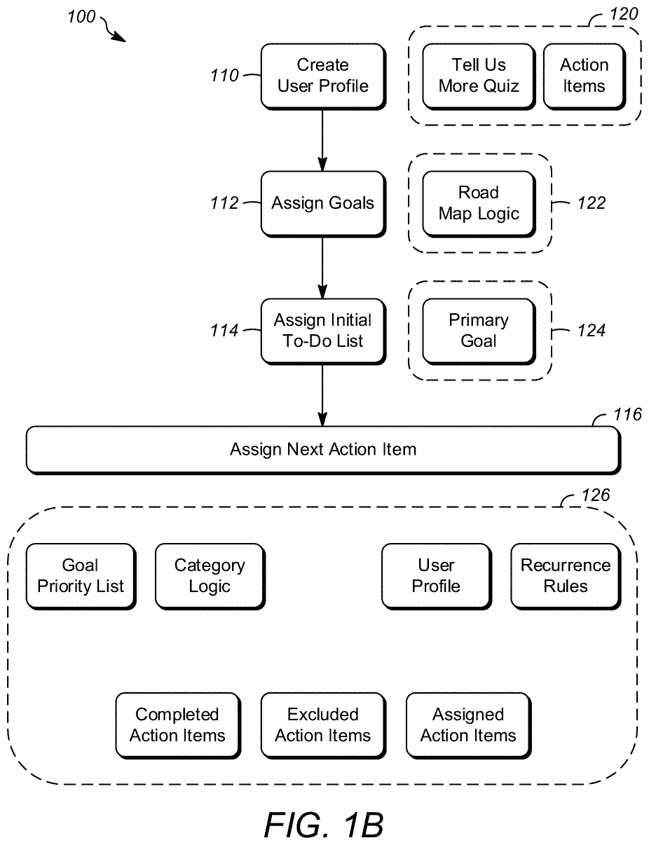

FIG. 1A illustrates a user specific action prioritization system 101. The user specific action prioritization system 101 may include a user specific action prioritization device 102 and a plurality of user devices 104 including first through fourth user devices 104-1-104-4. The user specific action prioritization device 102 and the plurality of user devices 104 are capable of performing wired and/or wireless communications with each other via communications network 108. The communications network 108 may be any network capable of transmitting electronic data. Example of the communications network 108 include, but are not limited to, a wireless communications network such as a cellular network or a WiFi network, a local area network (LAN), and the Internet.

According to at least one example embodiment of the inventive concepts, the user specific action prioritization device 102 may include or be implemented by one or more circuits or circuitry (e.g., hardware) specifically structured to carry out and/or control some or all of the operations described in the present disclosure as being performed by the user specific action prioritization device 102 (or an element thereof). According to at least one example embodiment of the inventive concepts, the user specific action prioritization device 102 may include or be implemented by a memory and one or more processors executing computer-readable code (e.g., software and/or firmware) that is stored in the memory and includes instructions for causing the one or more processors to carry out and/or control some or all of the operations described in the present disclosure as being performed by the user specific action prioritization device 102 (or an element thereof). According to at least one example embodiment of the inventive concepts, the user specific action prioritization device 102 may be implemented by, for example, a combination of the above-referenced hardware and one or more processors executing computer-readable code.

The user specific action prioritization device 102 may be, for example a desktop computer of a server. Each of the user devices 104 may each be, any one of, for example, a laptop, a desktop computer, a smart phone, a tablet, a personal digital assistant, and an a wearable device.

Referring to FIG. 1B, a representation of an example method for generating a user specific process 100 according to the principles of the present disclosure is shown. As is discussed in greater detail below with reference to FIGS. 1-4, in a non-limiting embodiment, the process 100 uses financial information of a user to intelligently select a series of action items for the user to complete in order to help the user achieve user-defined financial goals and/or goals that were assigned to the user by the process 100. In a non-limiting embodiment, the process 100 is executed by the user specific prioritization device 102.

Referring to FIG. 1B, at step 110 the process 100 begins with creating a user profile. Next, at step 112, the process 100 assigns goals to the user specific process 100. At step 114 the process 100 assigns an initial to-do list for the process 100. At step 116, the process 100 assigns the next action item for the user to complete in the process 100.

In a non-limiting embodiment, step 110 includes the sub-steps 120 in which the process 100 queries the user for personal information as well as specific action items. The personal information can include basic demographic information such as name, age, gender, and geographic location, along with identification of action items that the user is able to complete. In a non-limiting example, a user would not be able to complete an action item of paying off a car loan if the user did not first have a car loan.

In a non-limiting embodiment, step 110 involves creating a financial profile for the user by collecting financial information of the user. For example, the process 100 may query the user by presenting the user with a series of questions designed to elicit details of the user's financial information. Examples financial information of the user which the process 100 may collect in step 110 include, but are not limited to, the user's financial status, financial habits, financial concerns and/or financial goals.

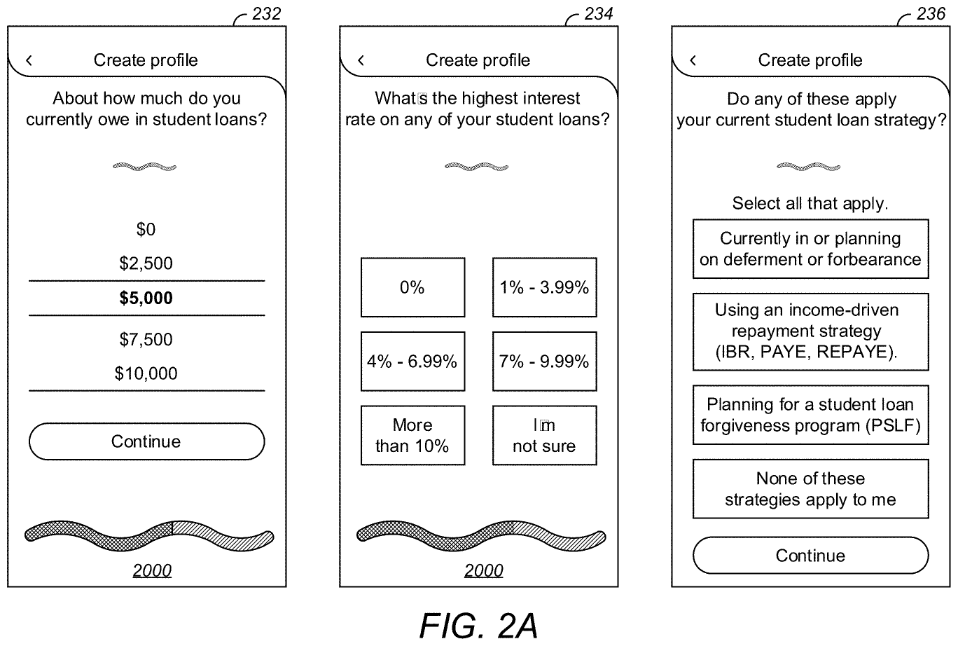

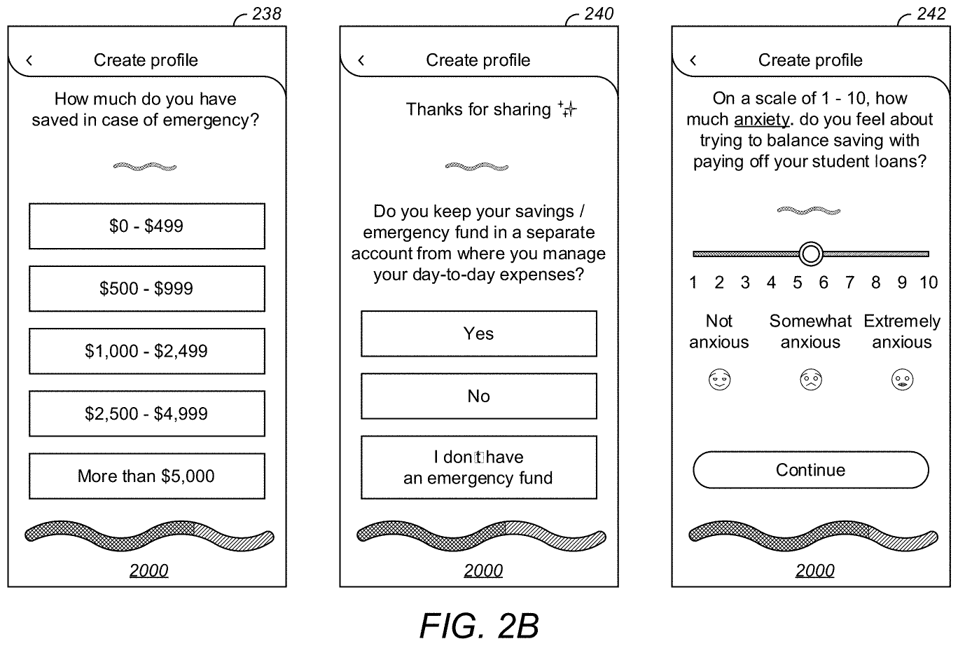

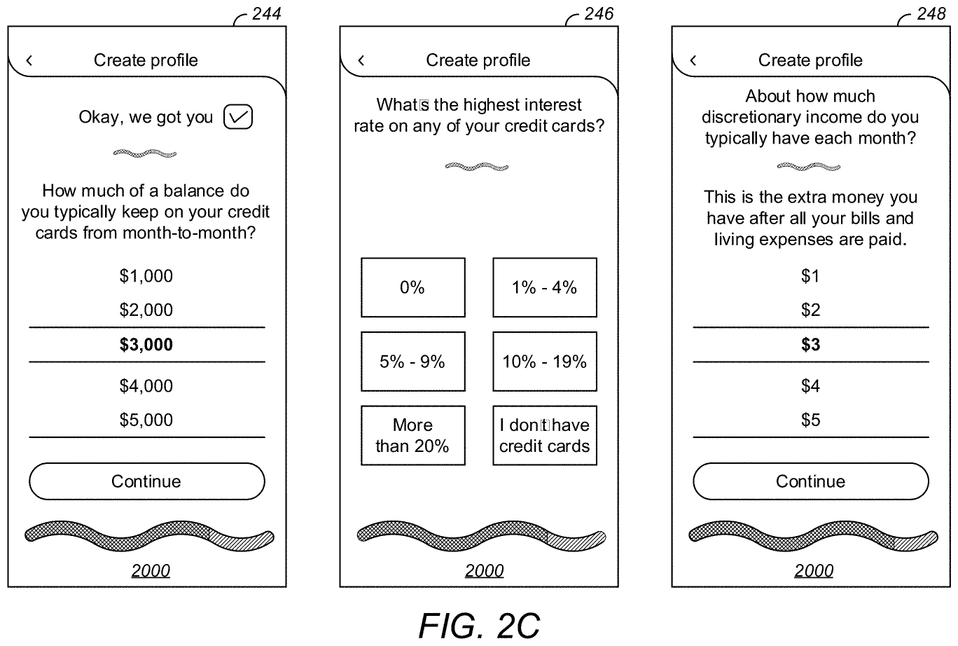

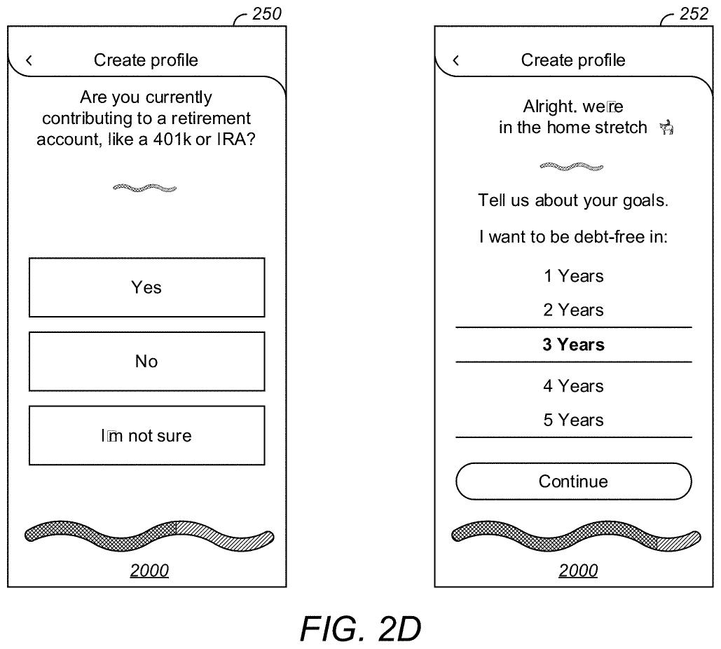

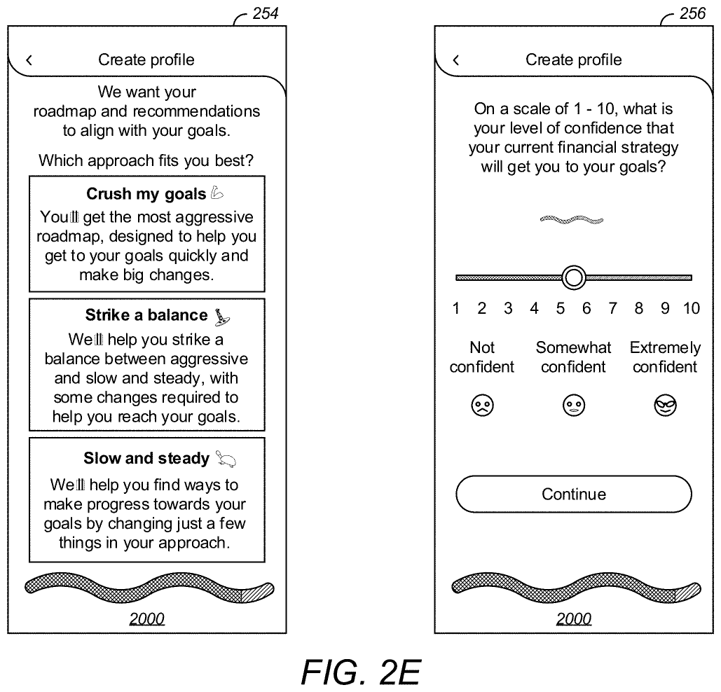

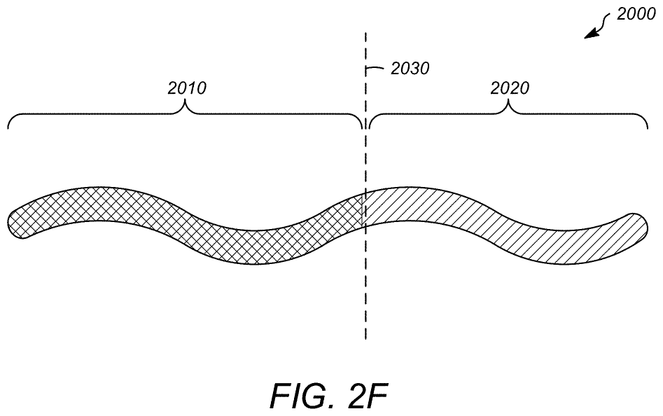

The process 100 may query the user to obtain the above-referenced user personal and/or financial information by, for example, presenting a series of questions to a display of a portable electronic device of the user. Examples of such a portable electronic device of the user include, but are not limited to, a smartphone, a tablet, a phablet, and a wearable electronic device. For example, FIGS. 2A-2E illustrate example screens for collecting financial information of the user in order to create the user's financial profile, according to the principles of the present disclosure. FIGS. 2A-2E illustrate example screens 232-256. Screens 232-256 each include a question for obtaining financial information of the user and may each be presented to a user via a display of the user's electronic device. As is also illustrated in FIGS. 2A-2E, one or more of example screens 232-256 include a progress indicator 2000. FIG. 2F illustrates the progress indicator 2000. According to at least some example embodiments, the progress indicator 2000 may have a shape of a sinusoidal waveform extending in a horizontal direction. The progress indicator 2000 may have a first portion 2010 and a second portion 2020 that meet at a boundary 2030. As a user progresses through screens 232-256 (e.g., by answering the questions therein), the boundary 2030 may shift horizontally (e.g., from left to right), and thus, the first portion 2010 may increase in size, and the second portion 2020 may decrease in size. According to at least some example embodiments, the first and second sections 2010 and 2020 are visually distinguishable from each other. For example, the first section 2010 may have a darker color than the second section 2020. Accordingly, a position of the boundary 2030 indicates an amount of progress a user has made in answering the questions within screens 232-256. Screens 232-256 of FIGS. 2A-2E will now be discussed in greater detail below.

Referring to FIG. 2A, screen 232 includes a question regarding an amount of student loan debt held by the user, screen 234 includes a question regarding a highest interest rate among student loans of the user, and screen 236 includes a question regarding whether a current student loan strategy of the user includes, deferment or forbearance, an income-driven repayment strategy, or a student loan forgiveness program. Referring to FIG. 2B, screen 238 includes a question regarding an amount of money the user has saved for an emergency, screen 240 includes a question regarding whether the user separates an account used for day-to-day expenses from an account used for savings or an emergency fund, and screen 242 includes a question regarding an amount of anxiety the user feels with respect to the task of balancing the objective of saving money with the objective of paying off student loans. Referring to FIG. 2C, screen 244 includes a question regarding a size of a balance the user typically keeps on their credit card month-to-month, screen 246 includes a question regarding a highest interest rate among the interests rates of all the user's credit cards, and screen 248 includes a question regarding an amount of discretionary income the user typically has in a month. Referring to FIG. 2D, screen 250 includes a question regarding whether or not the user is contributing to a retirement account (e.g., a 401k or individual retirement account (IRA)), and screen 252 includes a question regarding a user-selected goal of the user with respect to a time frame for the user becoming debt free. Referring to FIG. 2E, screen 254 includes a question regarding the users preferred approach for achieving the user's user-selected financial goals (e.g., aggressive/fast approach, slow/steady approach or balanced approach), and screen 256 includes a question regarding a level of confidence the user has in the prospect of the user's current financial strategy ultimately resulting in the user achieving their user-selected financial goals.

As is illustrated by screens 232-256 of FIGS. 2A-2E, the questions for obtaining the financial information of the user may use a conversational format (e.g., similar to in-person conversation, a text conversation or an online chat). For example, the process 100 may employ a basic logic when presenting questions to the user. As an example, if an answer given by the user indicates that the user has no student debt, then the process 100 may omit some or all remaining questions related to student debt. For example, referring to FIG. 2A, if the answer to the question regarding an amount of student debt owed by the user in screen 232 is “$0,” then the process 100 may omit screens 234 and 236, each of which include student loan debt-related questions. As another example, if the user provides an answer that indicates that the user has no credit cards, then the process 100 may omit screens 244 and 246 of FIG. 2C, each of which include credit card balance or interest rate questions.

In a non-limiting embodiment, creating a financial profile of the user in step 110 may further involve linking one or more of the user's financial accounts to the process 100. In a non-limiting embodiment, process 100 uses the system Plaid™ to link various financial accounts to the process 100. A system such as Plaid™ allows the process 100 to have access to the user's financial accounts such as their bank account so that the process 100 can properly monitor the user's financial status and assess the user's progress towards their user-selected financial goal. For example, the process 100 may be directed towards assisting the user in minimizing their debt.

In a non-limiting embodiment, step 112 includes sub-step 122 in which the process 100 further implements road map logic to help the user achieve the user's user-defined financial goal. For example, the process 100 may assign one or more goals to the user based on, for example, the financial information collected in step 110. Assigned goals may differ from user-selected financial goals in that assigned goals are selected for the user by the process 100 based on the user's financial profile. In contrast, a user-defined financial goal may be selected by the user during the process of generating the user's financial profile, as is discussed above with reference to step 110. In a non-limiting-embodiment, the road map logic arranges the user's top 3 assigned goals in the order of priority that they should be completed using basic personal finance methodology to assign goals including information from financial profile feeds to determine the order of goals. In a non-limiting embodiment, each assigned goal further includes an explanation to the user of why it was assigned in that particular order. For example, the process 100 may cause a display of an electronic device of the user to display information indicating why each assigned goal was given its current priority level (e.g., in response to the user selecting one of the assigned goals via the electronic device). In a non-limiting embodiment, a highest-priority goal from among a plurality of assigned goals of a user is the primary goal, the primary goal is active, and all other assigned goals of the user are inactive.

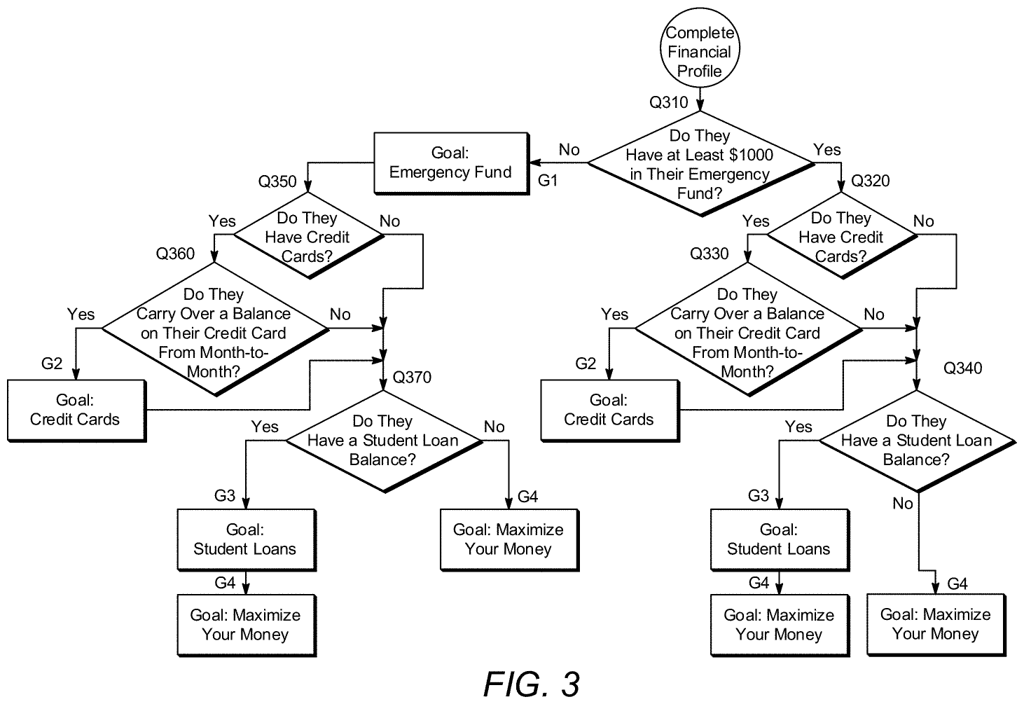

FIG. 3 is a flowchart depicting an example of a road map logic used in step 122 of process 100 for intelligently assigning goals to a user. FIG. 3 illustrates questions Q310-Q370 and goals G1-G4. Questions Q310-Q370 and goals G1-G4 are defined in Table 1, below:

TABLE 1

| | |
|---|---|
| Q310 | Does the user's emergency fund have at least $1000? |
| Q320 | Does the user have credit card? |
| Q330 | Does the user carry over a balance on their credit card |
| | from month-to-month? |
| Q340 | Does the user have a student loan balance? |
| Q350 | Does the user have credit card? |
| Q360 | Does the user carry over a balance on their credit card |
| | from month-to-month? |
| Q370 | Does the user have a student loan balance? |
| G1 | Goal: Emergency Fund (e.g., build emergency fund) |
| G2 | Goal: Credit Cards (e.g., pay off credit card debt) |
| G3 | Goal: Student Loans (e.g., pay off student loan(s)) |
| G4 | Goal: Maximize User's Money |

Questions Q310-Q370 correspond to questions presented by the process 100 to the user in step 110 for the purpose of building the user profile and/or a financial profile of the user. As is discussed in greater detail below, in step 122, the process 100 may use the roadmap logic illustrated in FIG. 3 to assign a primary goal to the user from among a plurality of potential assigned goals. In a non-limiting embodiment, the process 100 may use the roadmap logic illustrated in FIG. 3 to further assign a next primary goal when a current primary goal becomes inactive (e.g., because the goal has been achieved).

As is shown in FIG. 3, a particular sequence of answers to questions from among questions Q310-Q370 corresponds to a particular set and order of goals from among goals G1-G4 or, alternatively, disqualification DQ. For example, referring to FIG. 3, if the user provides, as a sequence of answers, [Q310 (No), Q350 (Yes), Q360 (Yes), Q370 (Yes)], the roadmap logic of the process 100 assigns goal G1 as the primary (i.e., active) goal of the user, and assigns remaining (i.e., inactive) goals of the user in the following order of priority: G2, G3, G4.

As another example, if the user provides, as a sequence of answers, [Q310 (No), Q350 (Yes), Q360 (Yes), Q370 (No)], the roadmap logic of the process 100 assigns goal G1 as the primary (i.e., active) goal of the user, and assigns inactive goals of the user in the following order of priority: G2, G4.

As yet another example, if the user provides, as a sequence of answers, [Q310 (Yes), Q320 (Yes), Q330 (Yes), Q340 (No)], the roadmap logic of the process 100 assigns goal G2 as the primary (i.e., active) goal of the user, and assigns G4 as an inactive goal of the user.

As another example, if the user provides, as a sequence of answers, [Q310 (Yes), Q320 (Yes), Q330 (Yes), Q340 (Yes)], the roadmap logic of the process 100 assigns goal G2 as the primary (i.e., active) goal of the user, and assigns remaining (i.e., inactive) goals of the user in the following order of priority: G3, G4.

Alternatively, in a non-limiting embodiment, the process 100 sets assigns goal G4 as primary, and sole, goal of a disqualified user, by default.

In a non-limiting embodiment, step 114 further includes sub-step 124 in which the user's initial to-do list is in furtherance of their primary goal. In a non-limiting example, the to-do list contains a combination of at least 3 action items from within the assigned goal's action item list. For example, if the user's primary goal includes reducing student loan debt, the action items on the to-do list may include engaging with a budgeting service, enrolling in a credit score service, or setting up an automatic withdrawal to pay down their debt.

In a non-limiting embodiment, step 116 further includes sub-step 126 where the process 100 assigns the next action item for the user. In a non-limiting embodiment, sub-step 126 assigns the next action item based on factors including, but not limited to, the primary goal list, predetermined category logic, the user created profile from step 110, recurrence rules, completed action items, excluded action items, and assigned action items. The action items are selected from the action item library, which may be periodically updated to include new action items. Action items in the action item library are categorized by subject matter to allow each action item to be associate with any number of goals.

FIG. 2 is a flowchart depicting an example process 400 for assigning action items 410 based on the goals 412. Process 400 includes goals 412, rules engine 414, and prioritized action item list 416 for specified goal 418. The goals 412 may be a list of one or more goals assigned by the road map logic (e.g., in sub-step 122) from step 112 of process 100. The goals 412 may further be prioritized based on the primary goal 124 and initial to-do list 114 from process 100. The goals 412 may further be selected by the user based on specific criteria identified when the user creates their profile in step 110.

Each of the goals 412 has a subset of action items 410 that are dynamically prioritized by rules engine 414. In a non-limiting example, rules engine 414 prioritizes action items 410 for specified goal 418 based on at least one factor including, but not limited to, the primary goal list, predetermined category logic, the user created profile from step 110, recurrence rules, completed action items, excluded action items, and assigned action items from sub-step 126. The action items 410 are selected from the action item library and each of the individual action items 410 can be associated with any number of goals 412, which allows for the rules engine 414 to dynamically generate a list of action items 410 for the specified goal 418 based on the factors described in sub-step 126.

The rules engine 414 establishes relationships between both goals 412 and action items 410 with conditions from sub-step 126 to identify the conditions that are required for a user to receive certain action items 410 from the rules engine 414. Stated differently, action items 410 will only be assigned to users that have met certain criteria that satisfy the requirements established by the rules engine 414. Action items 410 for a user that has met the criteria of the rules engine are identified as prioritized action items 420 that can be promoted to prioritized action item list 416. Action items 410 for which a user has not met the criteria of the rules engine 414 are flagged action items 422 and are not able to be promoted to the prioritized action item list 416.

As the user updates their profile from step 110, completes action items on the prioritized action items list 416, or completes goals 412, the rules engine continuously reevaluates and re-prioritizes the action items 410 to promote new action items 410 to the prioritized action item list 416. In a non-limiting example, a user may not be able to receive an action item to use a portion of their discretionary income to pay down an outstanding debt if the user does not have any discretionary income or if their discretionary income is not above a predetermined threshold. However, if the user identifies that they now have discretionary income or they complete an action item related to clearing the predetermined threshold for discretionary income, the rules engine 414 may then be able to promote the previously flagged action item 422 to the prioritized action item list 416.

In a non-limiting embodiment, processes 100 and 200 further associate articles, knowledge bases, and other forms of media with action items to assist the user in completing the action item. These other forms of media will also assist the user in understanding why the processes 100 and 200 and rules engine 414 prioritize certain action items 410.

In a non-limiting embodiment, processes 100 and 200 further conduct spending analysis on a user's finances by taking cloud data, through Plaid™ or other financial tracking systems, to provide the user with analysis of where the user is spending their money, what goods or services they are purchasing, and identifying trends in the user's spending habits. These trends are then used by processes 100 and 200 to dynamically link the user's spending habits to their assigned action items and goals.

In a non-limiting embodiment, processes 100 and 200 further include assistance with major action items to provide users with tools needed to achieve the major action items. By way of non-limiting example, a major action item may be an instruction to open up an Individual Retirement Account (IRA) and the processes 100 and 200 provide the user with a direct link and interface to a third-party through which the user can open up an IRA.

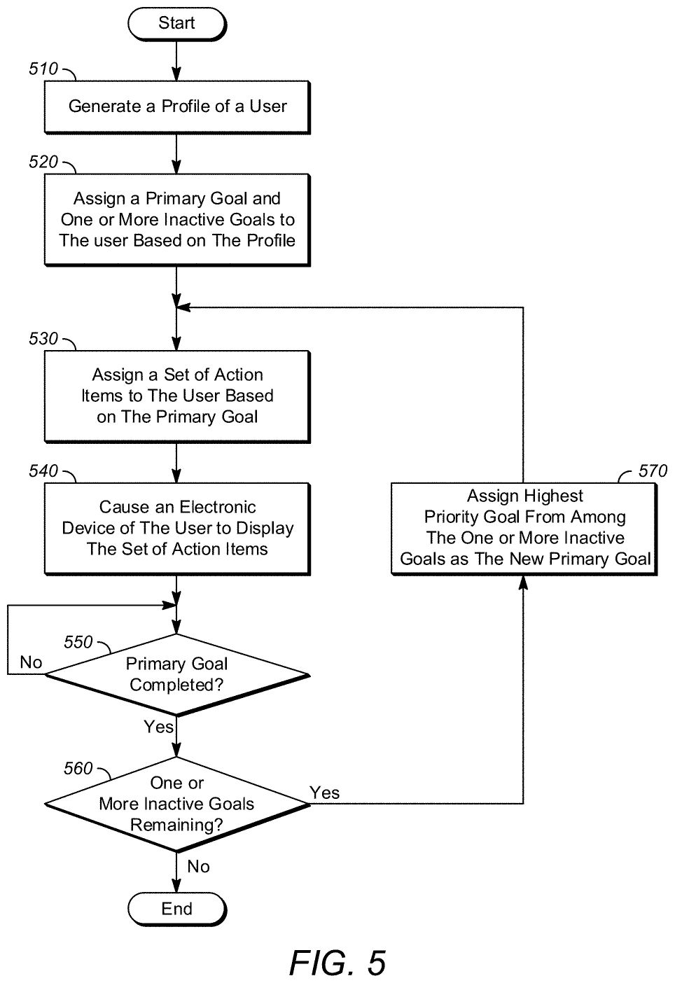

FIG. 5 is a flowchart of an example method for generating a user specific process according to the principles of the present disclosure. In step 510, the user specific action prioritization device 102 generate a profile of a user. For example, the user specific action prioritization device 102 may generate the profile of the user in the same manner discussed above with reference to step 110 of FIG. 1B and FIGS. 2A-2F.

In step 520, the user specific action prioritization device 102 assigns a primary goal and one or more inactive goals to the user based on the profile generated in step 510. For example, the user specific action prioritization device 102 may assign the primary goal and one or more inactive goals to the user in the same manner discussed above with reference to FIG. 1B (e.g., step 112) and FIG. 3.

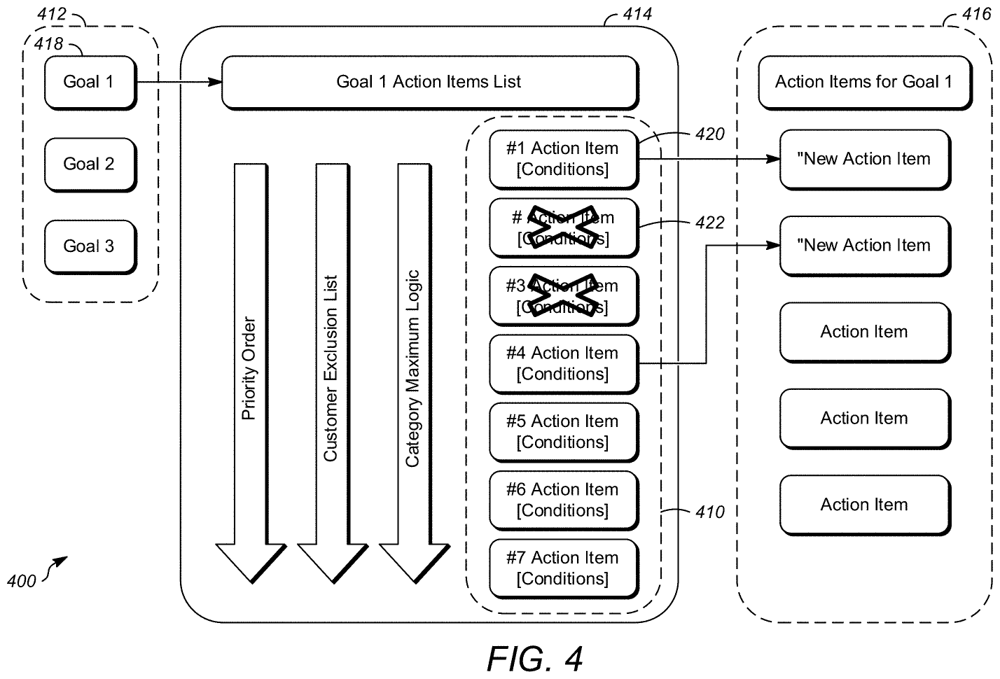

In step 530, the user specific action prioritization device 102 assigns a set of action items to the user based on the primary goal. For example, the user specific action prioritization device 102 assigns a set of action items to the user in the manner discussed above with reference to FIG. 1B (e.g., steps 114 and/or 116) and FIG. 4

In operation 540, the user specific action prioritization device 102 causes an electronic device of the user to display the set of action items assigned in step 530. For example, the user specific action prioritization device 102 may send information to an electronic device of the user (e.g., one of user devices 104-1-104-4) that causes a screen of the electronic device to display a screen including the assigned set of action items.

In operation 550, the user specific action prioritization device 102 determines whether the primary goal has been completed. According to at least some example embodiments, the user specific action prioritization device 102 may determine whether the primary goal has been complete based on one or more of completion of assigned action items, input from the user indicating the primary goal has been completed, and a comparison, by the user specific action prioritization device 102, of the parameters of the primary goal to current financial information of the user. As is discussed above with respect to process 100 in FIG. 1B, the user specific action prioritization device 102 may obtain financial information of the user, for example, based on initial or updated financial information provided by the user via an electronic device of the user and/or financial information obtained from financial accounts of the user to which the user specific action prioritization device 102 is linked.

If, in step 550, the user specific action prioritization device 102 determines that the primary goal has not yet been completed (i.e., “N” in step 550), according to at least some example embodiments, the user specific action prioritization device 102 continues to wait for the primary goal to be completed.

If, in step 550, the user specific action prioritization device 102 determines that the primary goal has been completed (i.e., “Y” in step 550), according to at least some example embodiments, the user specific action prioritization device 102 proceeds to step 560.

In step 560, the user specific action prioritization device 102 determines whether one or more of the inactive goals assigned to the user (e.g., in step 520) remain (e.g., remain uncompleted).

If, in step 560, the user specific action prioritization device 102 determines one or more inactive goals assigned to the user remain (i.e., “Y” in step 560), according to at least some example embodiments, the user specific action prioritization device 102 proceeds to step 570.

In step 570, the user specific action prioritization device 102 assigns a highest priority goal, from among the one or more inactive goals assigned to the user, as the new primary goal. For example, as is discussed above with reference to FIG. 3 and operation 112 of FIG. 1B, the user specific action prioritization device 102 may use a roadmap logic assign priorities to inactive goals.

After the user specific action prioritization device 102 assigns a new primary goal to the user in step 570, the user specific action prioritization device 102 returns to operation 530, and assigns a set of action items to the user based on the new primary goal that was assigned in step 570.

Alternatively, if, in step 560, the user specific action prioritization device 102 determines that no inactive goals assigned to the user remain (i.e., “N” in step 560), according to at least some example embodiments, the user specific action prioritization device 102 ends the method for generating a user specific process of FIG. 5.

Thus, according to at least some example embodiments, the user specific action prioritization device 102 may iterate through inactive goals assigned to the user by continuously selecting a highest priority inactive goal as the new primary goal of the user and assigning action items corresponding to the new primary goal to the user until no more inactive goals assigned to the user remain.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. The phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
a memory configured to store a plurality of action items and
a rules engine configured to order the action items based on at least one of a plurality of conditions, the conditions including a user profile, a goal priority list, an action item category, a recurrence rule, a completed action item, an excluded action item, and an assigned action item,
wherein the rules engine is configured to:
dynamically re-order the ordered action items in response to a status change in any of the plurality of action items and
dynamically re-order the ordered action items in response to a condition change in any of the plurality of conditions.

2. A method comprising:
generating a profile of a user;
based on the profile, assigning a goal, from among a plurality of goals, as a primary goal of the user, wherein the plurality of goals correspond, respectively, to a plurality of sets of action items from among a plurality of action items;
assigning a first set of action items, from among the plurality of action items, to an action item list of the user, wherein the first set of action items is the set of action items, from among the plurality of sets of action items, that corresponds to the primary goal; and
causing an electronic device to display the first set of action items.

3. The method of claim 2, wherein generating the profile of the user comprises:
presenting, by the electronic device, the user with first questions from among plurality of questions and
obtaining first answers corresponding to the first questions.

4. The method of claim 3, further comprising:
determining, based on an answer provided by the user, at least one question from among the plurality of questions to be irrelevant and
omitting the determined at least one question from the first questions.

5. The method of claim 2, further comprising:
based on the profile of the user, assigning one or more goals, other than the primary goal, from among the plurality of goals, as one or more inactive goals of the user.

6. The method of claim 5, wherein:
the one or more inactive goals includes at least two inactive goals and
a priority order of the at least two inactive goals is based on the profile of the user.

7. The method of claim 6, further comprising:
in response to the primary goal being completed, setting the inactive goal having a highest priority among the at least two inactive goals as a new primary goal.

8. The method of claim 7, further comprising:
assigning a second set of action items, from among the plurality of action items, to the action item list of the user, wherein the second set of action items is the set of action items, from among the plurality of sets of action items, that corresponds to the new primary goal; and
causing the electronic device to display the second set of action items.

9. The method of claim 8, wherein generating the profile of the user comprises:
presenting, by the electronic device, the user with first questions from among plurality of questions and
obtaining first answers corresponding to the first questions.

10. The method of claim 9, further comprising:
determining, based on an answer provided by the user, at least one question from among the plurality of questions to be is irrelevant and
omitting the determined at least one question from the first questions.

11. The method of claim 8, further comprising:
based on the profile of the user, assigning one or more goals, other than the primary goal, from among the plurality of goals, as one or more inactive goals of the user,
wherein the one or more inactive goals includes at least two inactive goals, and
wherein a priority order of the at least two inactive goals is based on the profile of the user.

12. A computer system comprising:
memory storing computer-executable instructions and
a processor configured to execute the computer-executable instructions, wherein the computer-executable instructions include:
generating a profile of a user,
based on the profile, assigning a goal, from among a plurality of goals, as a primary goal of the user, wherein the plurality of goals correspond, respectively, to a plurality of sets of action items from among a plurality of action items,
assigning a first set of action items, from among the plurality of action items, to an action item list of the user, wherein the first set of action items is the set of action items, from among the plurality of sets of action items, that corresponds to the primary goal, and
causing an electronic device to display the first set of action items.

13. The computer system of claim 12, wherein generating the profile of the user includes:
presenting, by the electronic device, the user with first questions from among plurality of questions and
obtaining first answers corresponding to the first questions.

14. The computer system of claim 13, wherein the computer-executable instructions include:
determining, based on an answer provided by the user, at least one question from among the plurality of questions to be irrelevant and
omitting the determined at least one question from the first questions.

15. The computer system of claim 12, wherein the computer-executable instructions include:
based on the profile of the user, assigning one or more goals, other than the primary goal, from among the plurality of goals, as one or more inactive goals of the user.

16. The computer system of claim 15, wherein:
the one or more inactive goals includes at least two inactive goals and
a priority order of the at least two inactive goals is based on the profile of the user.

17. The computer system of claim 16, wherein the computer-executable instructions include:
in response to the primary goal being completed, setting the inactive goal having a highest priority among the at least two inactive goals as a new primary goal.

18. The computer system of claim 17, wherein the computer-executable instructions include:
assigning a second set of action items, from among the plurality of action items, to the action item list of the user, wherein the second set of action items is the set of action items, from among the plurality of sets of action items, that corresponds to the new primary goal; and
causing the electronic device to display the second set of action items.

19. The computer system of claim 18, wherein generating the profile of the user includes:
presenting, by the electronic device, the user with first questions from among plurality of questions and
obtaining first answers corresponding to the first questions.

20. The computer system of claim 19, wherein the computer-executable instructions include:
determining, based on an answer provided by the user, at least one question from among the plurality of questions to be is irrelevant and
omitting the determined at least one question from the first questions.
